(19) United States
(12) Patent Application Publication
(10) Pub. No.: US 2025/0390255 A1
(43) Pub. Date: Dec. 25, 2025

(54) NON-TRANSITORY COMPUTER-READABLE STORAGE MEDIUM STORING INSTRUCTIONS IMPLEMENTING SUPPORTING PROGRAM

(71) Applicant: BROTHER KOGYO KABUSHIKI KAISHA, Nagoya (JP)

(72) Inventors: Kenju NARITA, Nagoya (JP); Yushi ICHIKAWA, Nagoya (JP); Yoshito HOSOMIZO, Konan (JP); Airi EGUCHI, Ichinomiya (JP)

(21) Appl. No.: 19/309,975

(22) Filed: Aug. 26, 2025

Related U.S. Application Data
(63) Continuation of application No. PCT/JP2024/005984, filed on Feb. 20, 2024.

(30) Foreign Application Priority Data
Feb. 28, 2023 (JP) 2023-029550

(51) Int. Cl. G06F 3/12

(52) U.S. Cl. CPC G06F 3/1207; G06F 3/121; G06F 3/1234; G06F 3/1259

(57) ABSTRACT

A supporting program for a printer, when executed by a controller of an information processing device having an operating system with a universal printing program and an application program, the supporting program causing the information processing device to perform, in response to the universal printing program receiving a print instruction from the application program, causing the printer to print an image, and receiving an end event from the universal printing program. The end event is output in response to the universal printing program receiving an end notification from the printer as a result of processing the print job. The supporting program causes the information processing device to perform, in response to receiving the end event, obtaining screen information including information associated with an end of the print job in the printer, and displaying a notification screen based on the screen information on a user interface of the information processing device.

### REFERENCE TO RELATED APPLICATIONS

This is a continuation application of International Application No. PCT/JP2024/005984 filed on Feb. 20, 2024, which claims priority from Japanese Patent Application No. 2023-029550 filed on Feb. 28, 2023. The entire contents of the aforementioned applications are incorporated herein by reference.

### BACKGROUND ART

Some known techniques have been developed for controlling a printer using an OS-standard universal printing program that is part of an operating system (OS), without a printer driver provided by a printer vendor. More specifically, for example, in response to detecting a printer, the OS may establish association between the printer and the OS-standard universal printing program. Thereafter, in response to the OS receiving a print instruction for the printer, the OS-standard universal printing program may generate print data without a printer driver provided by a printer vendor, thereby enabling printing through the OS-standard universal printing program.

For example, one technique involves performing printing via an OS-standard universal printing program. More specifically, a supporting program activated by the universal printing program in response to a print instruction repeatedly obtains status information from a printer, and passes the obtained status information to an editing application.

### SUMMARY

After print data is transmitted from an information processing device to a printer, a user might not be able to know when a print job based on the print data ends in the printer unless the user is physically near the printer. Therefore, it may be preferable for the information processing device to notify the end of a print job in the printer when the print job ends. Nevertheless, the universal printing program might not have a function of notifying the end of a print job in the printer. As described above, after a print instruction is issued, the supporting program may notify of the end of the print job in the printer by obtaining status information from the printer. Nevertheless, the supporting program may repeatedly obtain status information, which may result in a higher communication load on the supporting program.

According to an aspect of the disclosure, a non-transitory computer-readable storage medium for an information processing device is provided, which includes a controller and stores computer-executable instructions that are executable by the controller. The computer-executable instructions implement a supporting program for a printer connectable to the information processing device. The information processing device has an operating system including a universal printing program. The information processing device is incorporated with an application program. The supporting program, when executed by the controller, causes the information processing device to perform, in response to the universal printing program receiving, from the application program, a print instruction for a print job that causes the printer to print an image to be printed, printing processing of causing the printer to process the print job to print the image to be printed; receiving processing of receiving an end event from the universal printing program, the end event being output by the universal printing program in response to the universal printing program receiving an end notification from the printer as a result of processing the print job; in response to receiving the end event from the universal printing program, screen information obtaining processing of obtaining screen information including information associated with an end of the print job in the printer; and notification processing of displaying a notification screen based on the screen information on a user interface of the information processing device.

As described above, in response to receiving the end event, which is output by the universal printing program in response to the print instruction, the supporting program may display the notification screen including the information associated with the end of the print job in the printer on the user interface. Such a configuration may thus enable the user to obtain the necessary information when the print job ends in the printer. The supporting program thus might not need to monitor the printer after transmission of print data. Thus, a communication load on the supporting program may be lightened when the end of the print job in the printer is notified.

Apparatuses and control methods for implementing the functions of the supporting program may also have novelty and utility.

According to aspects of the disclosure, a technique for reducing communication load and notifying the end of a print job in a printer may be implemented in an information processing device in which an OS-standard universal printing program is installed.

### BRIEF DESCRIPTION OF THE DRAWINGS

FIG. 1 is a block diagram schematically illustrating an electrical configuration of a personal computer.

FIG. 2 is a sequence diagram illustrating an example of a print execution procedure.

FIG. 3 illustrates an example of a completion notification screen.

FIG. 4 illustrates an example of a cancellation notification screen.

FIG. 5 illustrates an example of an error notification screen.

FIG. 6 is a flowchart illustrating an example of a restriction setting process.

FIG. 7 is a sequence diagram illustrating another example of the print execution procedure.

### DESCRIPTION

Hereinafter, a personal computer (“PC”) using a supporting program of an illustrative embodiment will be described in detail with reference to the accompanying drawings. The disclosure discloses the supporting program executed by the PC.

### First Illustrative Embodiment

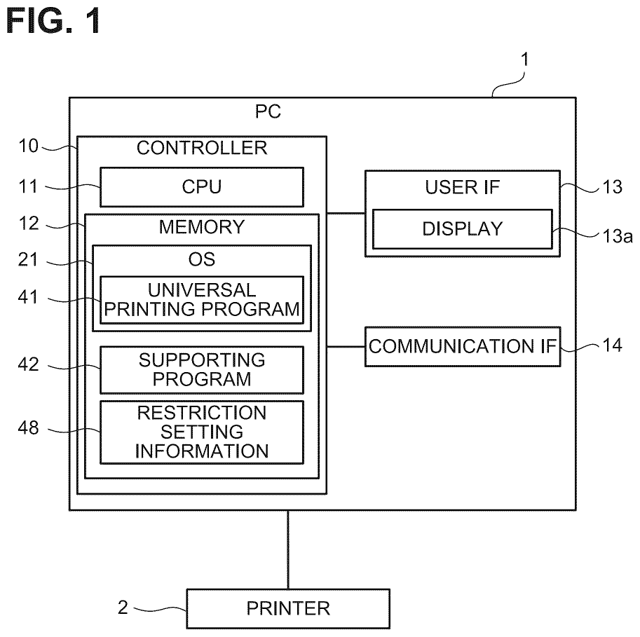

As illustrated in FIG. 1, a PC 1 of the illustrative embodiment includes a controller 10 including a CPU 11 and a memory 12. The PC 1 is an example of an information processing device. The CPU 11 is an example of a computer. The PC 1 includes a user interface (“user IF”) 13 and a communication interface (“communication IF”) 14, which are electrically connected to the controller 10. The term “controller 10” used in FIG. 1 may be a collective term for hardware and software used to control the PC 1, and might not necessarily represent a single piece of hardware actually existing in the PC 1.

The CPU 11 of the PC 1 executes various types of processing in accordance with a program read from the memory 12 or based on user input. The memory 12 stores various programs and data. The memory 12 also serves as a workspace for processing. A buffer of the CPU 11 is an example of the memory 12. Examples of the memory 12 further include storage media readable and writable by the CPU 11, for example, recording media such as CD-ROMs and DVD-ROMs, as well as a ROM, a RAM, a hard disk drive built in the PC 1.

The user IF 13 includes a display 13a, which is hardware for displaying information to a user. Further, the user IF 13 includes hardware for user input. In one example, the user IF 13 may be a combination of the display 13a and an input device, such as a mouse and/or a keyboard. In another example, the user IF 13 may be a touch screen having both display and input functions.

The communication IF 14 includes hardware that enables the PC 1 to communicate with an external device such as the printer 2. Examples of a communication standard for the communication IF 14 include Ethernet, Wi-Fi, and USB. Wi-Fi is a registered trademark of Wi-Fi Alliance. The PC 1 may be connectable to the Internet via the communication IF 14. The PC 1 may include multiple communication IFs 14 for supporting multiple communication standards.

As illustrated in FIG. 1, the memory 12 of the PC 1 stores various programs and data. The program may include, for example, an operating system (“OS”) 21, a supporting program 42, and an editing application 43. The OS 21 includes a universal printing program 41. The data may include, for example, restriction setting information 48. The supporting program 42 is an example of a supporting program. The editing application 43 is an example of an application program. The restriction setting information 48 will be described later.

The OS 21 may be a multitasking OS that manages multiple tasks and switches between the multiple tasks, thereby handling several tasks simultaneously. The OS 21 may be, for example, Windows, macOS, Linux, iOS, or Android. Windows is a trademark of the Microsoft group of companies. macOS is a trademark of Apple Inc., registered in the U.S. and other countries and regions. Linux is the registered trademark of Linus Torvalds in the U.S. and other countries. IOS is a trademark or registered trademark of Cisco Systems, Inc. in the U.S. and other countries and is used under license. Android is a registered trademark of Google LLC.

The OS 21 includes the universal printing program 41. The universal printing program 41 is an OS-standard program that is developed by a vendor of the OS 21 and provided as part of the OS 21. The universal printing program 41 is designed to allow for the absence of printer-specific drivers.

The universal printing program 41 enables various types and models of printers provided by different vendors to perform printing based on user instructions. The universal printing program 41 supports general functions that enable various printers to perform printing. Unlike printer-specific drivers, the universal printing program 41 does not support a specific function that a printer or printer driver has, in particular, a function requiring complicated processing.

The universal printing program 41 includes a function of generating intermediate image data based on image data received as data to be printed that has been specified in a print instruction received from an application, based on a user instruction. The intermediate image data may be, for example, data in XPS format. “XPS” is an abbreviation for XML Paper Specification. The universal printing program 41 further has a function of generating print data in a format available for printing by various types of printers based on the intermediate image data. The print data may be, for example, PWG Raster data or PDF data. The universal printing program 41 further has a function of transmitting the generated print data to a printer designated as a device for printing, using a communication function of the OS 21.

The supporting program 42 consists of a single program or a group of programs that execute processing based on an instruction received from the OS 21 in association with the processing executed by the universal printing program 41, and that support control of target hardware. The supporting program 42 is provided for the model of the printer 2 connected to the PC 1, for example, by the vendor of the printer 2. The universal printing program 41 activates the supporting program 42 for the printer 2 based on a specific condition. The specific condition may be, for example, the designation of the printer 2 as a device for printing, the reception of an instruction to specify advanced print settings while the printer 2 is designated, or the reception of an instruction to cause the printer 2 to perform printing. The supporting program 42 may be, for example, a Print Support Application (“PSA”) or a Hardware Support Application (“HSA”).

In one example, the supporting program 42 may be a combination of a plurality of programs that receive execution commands, respectively. In another example, the supporting program 42 may be a single program configured to execute different types of processing based on received commands. Supporting programs may be prepared for different types of printers by a printer vendor. For example, one supporting program may be for inkjet printers and another supporting program may be for laser printers. Supporting programs may be prepared not only for types of printers but also for different models of printer or different series of printer models.

For example, when a particular printer is connected to the PC 1 for the first time, the OS 21 of the PC I may download a supporting program appropriate for the type or model of the printer from a server of the vendor of the printer, and install the supporting program on the PC 1. The OS 21 stores identification data of the installed supporting program into the memory 12 in association with printer data of the newly connected printer.

The editing application 43 may be, for example, a program for creating and editing image data and/or document data. The editing application 43 may be, for example, Microsoft Word or Microsoft PowerPoint developed by Microsoft or may be a program provided by the vendor of the printer 2. Microsoft, Microsoft PowerPoint, and Microsoft Word are trademarks of the Microsoft group of companies. The editing application 43 may receive, via the user IF 13, for example, a print execution instruction to cause the printer 2 to perform printing. The editing application 43 is not limited to programs for creating and editing data, and may also include programs that have a function of receiving instructions to display or print various types of information, such as map information or web pages, in response to a user's request.

As illustrated in FIG. 1, the PC 1 of the illustrative embodiment is connected to the printer 2 via the communication IF 14. The printer 2 has at least a printing function and a communication function. For example, in response to receiving print data from the PC 1, the printer 2 may perform printing based on the received print data. The printer 2 of the illustrative embodiment is a color printer. In other embodiments, for example, the printer 2 may be a monochrome printer.

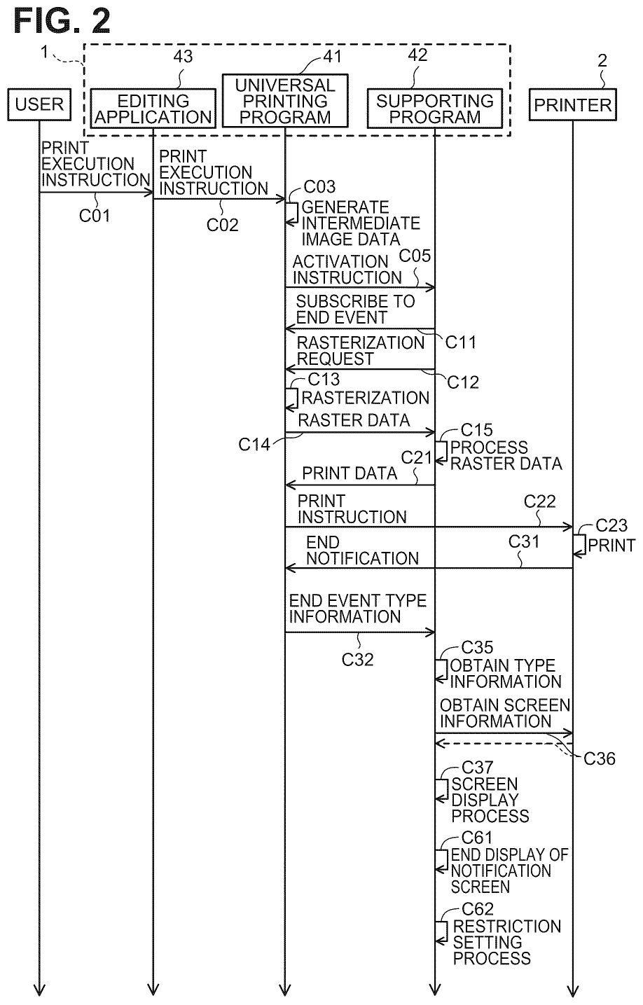

Next, a print execution procedure for causing the printer 2 to perform printing will be described with reference to FIG. 2. Here, as an example, the print execution procedure will be described in a case where the PC 1 designates the printer 2, which is a color printer, to perform printing.

Processing executed in each step in the illustrative embodiment essentially indicates processing executed by the CPU 11 in accordance with instructions written in a specific program, such as the supporting program 42. Processing executed by the CPU 11 also includes control of hardware using APIs of the OS 21. In the disclosure, a description will be provided on operations of the programs. A detailed description of the OS 21 will be omitted. The terms referring to coming into possession are used as a concept that does not require necessarily a request to obtain that possession.

After finalizing the image to be printed and the print settings for the printer 2, the user provides a print execution instruction via the editing application 43 (C01). The editing application 43 can display an editing screen and a print settings screen. The editing application 43 receives instructions from the user to create or edit a document or image via the editing screen. In response to receiving a selection of a printing function via the editing screen, the editing application 43 displays the print settings screen. The editing application 43 allows the user to designate a printer to be used for printing or specify various parameters on the print settings screen. More specifically, for example, based on the user's selection of a “Print” button on the print settings screen, the editing application 43 determines that a print execution instruction for the universal printing program 41 has been received. The print execution instruction instructs the printer 2 to print the specified image.

The editing application 43 passes the details of the print execution instruction to the universal printing program 41 (C02). The universal printing program 41 thus obtains image data representing the image to be printed and the print settings, as the details of the print execution instruction, from the editing application 43.

The universal printing program 41 generates intermediate image data by converting the image data to an intermediate image data format based on the print settings received from the editing application 43 (C03). The image data included in the editing application 43 is of various types. The universal printing program 41 thus converts the received image data to intermediate image data suitable for generating print data. Nevertheless, in other embodiments, for example, when the received image data is in a suitable format, the generation of intermediate image data may be omitted, and the image data may be used as intermediate image data without any conversion.

Prior to generating the intermediate image data, the universal printing program 41 may activate the supporting program 42 for the designated device, which may be the printer 2, and notify that processing for a print job has been started. In a case where the supporting program 42 is activated by the universal printing program 41, the supporting program 42 is allowed to pass various instructions to be used in the generation of intermediate image data, to the universal printing program 41 as necessary.

After generating the intermediate image data, the universal printing program 41 activates the supporting program 42 (C05). The supporting program 42 may obtain the intermediate image data generated by the universal printing program 41 by requesting the intermediate image data from the universal printing program 41. Then, the supporting program 42 may modify the intermediate image data received from the universal printing program 41 or print settings information, based on the print settings received via the print settings screen.

The supporting program 42 subscribes to an end event from the universal printing program 41 (C11). An end event can be output from the universal printing program 41 when the universal printing program 41 receives an end notification from the printer 2 used for printing. The end notification indicates that the current print job has ended. Subscribing to an end event from the universal printing program 41 enables the supporting program 42 to receive an end event from the universal printing program 41.

The timing for subscribing to an end event (refer to step C11) can be at any time after the supporting program 42 is activated in response to a print instruction (i.e., after the supporting program 42 receives an activation instruction in step C05) and before the supporting program 42 executes a printing process (i.e., before the supporting program 42 outputs print data in step C21). In the illustrative embodiment, the supporting program 42 subscribes to an end event from the universal printing program 41 every time a print instruction is provided. Nevertheless, if the universal printing program 41 can maintain the end event subscription, the supporting program 42 may omit step C11.

The supporting program 42 passes the intermediate image data, and requests the universal printing program 41 to rasterize the intermediate image data (C12). The universal printing program 41 thus rasterizes the intermediate image data to generate raster data (C13). The raster data may be bitmap data. The universal printing program 41 then passes the generated raster data to the supporting program 42 (C14). The supporting program 42 thus obtains the raster data.

In other embodiments, for example, the supporting program 42 may perform rasterization instead of the universal printing program 41. More specifically, the supporting program 42 rasterizes the intermediate image data included in the received print execution instruction to generate raster data. Rasterization by the supporting program 42 may provide greater flexibility in rasterization than the universal printing program 41, which is likely to result in raster data that is suitable for printing by the printer 2. However, rasterization by the universal printing program 41 may enable the supporting program 42 to execute less processing, and may reduce the program size of the supporting program 42.

Subsequent to C14, the supporting program 42 processes the raster data obtained in step C14 as necessary, and encodes the processed raster image into PDL data to generate print data (C15). Subsequent to step C15, the supporting program 42 passes the generated print data to the universal printing program 41 and instructs the universal printing program 41 to transmit the print data to the printer 2 (C21). Step C21 is an example of “printing processing”.

The print data to be passed from the supporting program 42 to the universal printing program 41 in step C21 of FIG. 2 may be any type as long as the print data is in a format that can be printed by the printer 2. The PDL data generated by the supporting program 42 may be in a format that can be printed by printers in addition to models of the printer 2.

In response to the instruction received from the supporting program 42, the universal printing program 41 transmits the print data to the printer 2 and instructs the printer 2 to perform printing (C22). In response to the print instruction, the printer 2 performs printing based on the received print data (C23). Thus, a printed matter based on the print instruction output from the editing application 43 is outputted.

The printer 2 that performs printing notifies the universal printing program 41 of the end of the print job (C31). Examples of print job end types include “print completion”, “print cancellation”, and “termination due to an error”. The printer 2 can transmit an end notification including type information indicating an end type to the universal printing program 41.

In response to receiving, from the printer 2, the end notification including the end type, the universal printing program 41 outputs an end event based on the established end event subscription (C32). The universal printing program 41 outputs the type information included in the end notification received from the printer 2, together with the end event.

The universal printing program 41 of the illustrative embodiment does not have a function of notifying the PC 1 of the end of the current print job. Thus, even when the universal printing program 41 receives the end notification from the printer 2, the universal printing program 41 outputs an end event and type information without notifying the end of the print job.

The supporting program 42 obtains the end event and the type information received from the universal printing program 41 (C35). Step C35 is an example of “end type obtaining processing”. The supporting program 42 can obtain the type information without communicating with the printer 2.

In one example, the error notification may include an end code. Each end code uniquely identifies a print job end type. In this case, the universal printing program 41 may output an end event associated with the end code. The supporting program 42 may obtain the type information by analyzing the type of the end event.

In other embodiments, for example, in a case where the end notification transmitted from the printer 2 includes type information but the universal printing program 41 outputs an end event that does not specify the end type of the current print job, the supporting program 42 may obtain the type information included in the end notification received from the universal printing program 41. In this case, also, the supporting program 42 can obtain the type information from the universal printing program 41 without communicating with the printer 2.

In another example, in a case where the end notification transmitted from the printer 2 does not include the type information, the supporting program 42 may obtain the type information from the printer 2. In this case, the supporting program 42 may obtain the type information from the printer 2 via the universal printing program 41. At this time, the universal printing program 41 communicates with the printer 2 via the OS 21 in compliance with, for example, the Internet Printing Protocol (“IPP”). The supporting program 42 may obtain the type information directly from the printer 2, using, for example, the Management Information Base (“MIB”).

The supporting program 42 obtains screen information for the type information obtained in step C35 (C36). Step C36 is an example of “screen information obtaining processing”. The screen information is used when a notification screen that notifies an end of a print job in a printer is displayed. The screen information includes information associated with the end of the print job in the printer 2. Examples of the information associated with the end of the print job in the printer include information indicating the end of the print job, the printer name, the file name, the job information, and the status information.

Examples of the information indicating the end of the print job include information to notify the result of processing a print job or an end status of the print job, such as “print completion”, “print cancellation”, or “termination due to an error”. For example, in a case where the information indicating the end of the print job is stored in a nonvolatile storage area for the supporting program 42 in the memory 12, the supporting program 42 retrieves, from the memory 12, the information according to the type information obtained in step C35. The information indicating the end of the print job may be stored in the printer 2 or may be stored in an external device such as a server.

The printer name identifies the printer that has ended the current print job. The printer name may be included in the end notification from the printer 2, or may be stored in advance in the supporting program 42.

The file name identifies the file to be printed based on a print instruction. The job information includes data items related to the job corresponding to the print instruction. Examples of the data items of the job information include progress, power consumption, and consumable consumption. For example, the power consumption and the consumable consumption are determined according to the number of sheets to be printed with reference to the power consumption and the consumable consumption per sheet.

The status information includes data items based on the status of the printer that has ended the print job. Examples of the data items of the status information include a printer status, consumable levels, and an output tray status. Examples of the consumables include an ink cartridge or ink, a toner cartridge or toner, and a sheet. For example, in a case where the print job ends duc to termination caused by an error, the supporting program 42 obtains the error type as the printer status. Examples of the error types include “Cover Open”, “Empty Consumable”, “Near Empty Consumable”, “Low Consumable”, “No Sheet”, “Sheet Jam”, “Full Output Tray”, and “Almost Full Output Tray”. For example, when the printer is a color printer, an insufficient consumable error may be determined for each color.

The supporting program 42 may directly obtain the information about the end of the print job such as the file name, the job information, and the status information, from the printer 2. In a case where the end notification includes the information about the end of the print job, such as the file name, the job information, and the status information, the supporting program 42 may obtain those information from the universal printing program 41. In a case where the file name, the job information, and the status information, which are the information associated with the end of the print job, are stored in multiple locations, for example, in the printer 2, the universal printing program 41, the memory 12, and other locations, the supporting program 42 may obtain those information from each storage location in step C36.

The supporting program 42 notifies the end of the print job in the printer 2 (C37). More specifically, based on the screen information obtained in C36, the supporting program 42 displays the notification screen for the type information obtained in step C35 on the display 13a of the PC 1. Step C37 is an example of “notification processing”. As described above, even when the universal printing program 41 does not have a function of notifying the end of the print job in the printer 2, the supporting program 42 displays the notification screen that notifies the end of the print job on the PC 1. This may thus enable the user to recognize the end of the print job in the printer 2 even when the user is not physically near the printer 2.

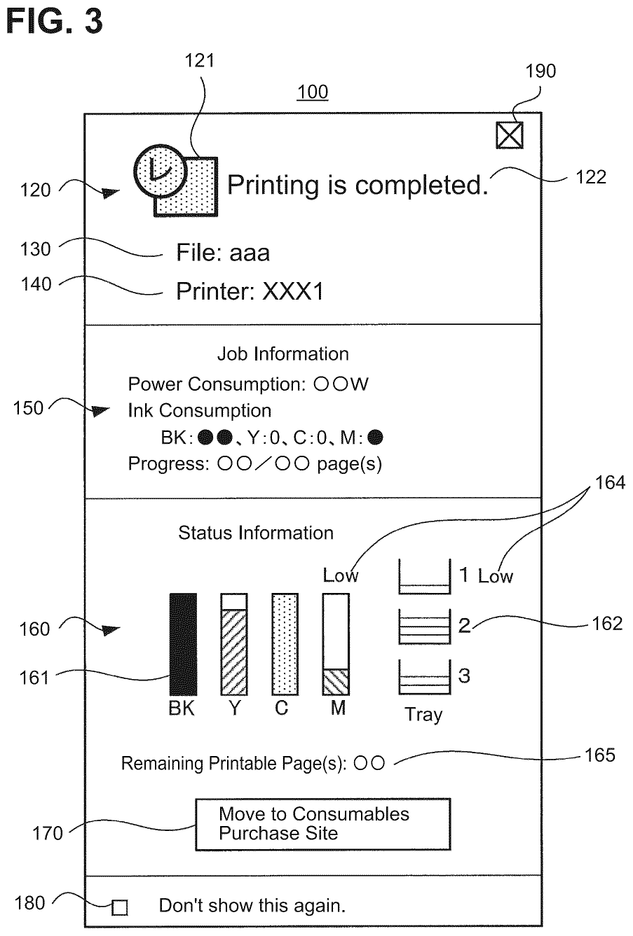

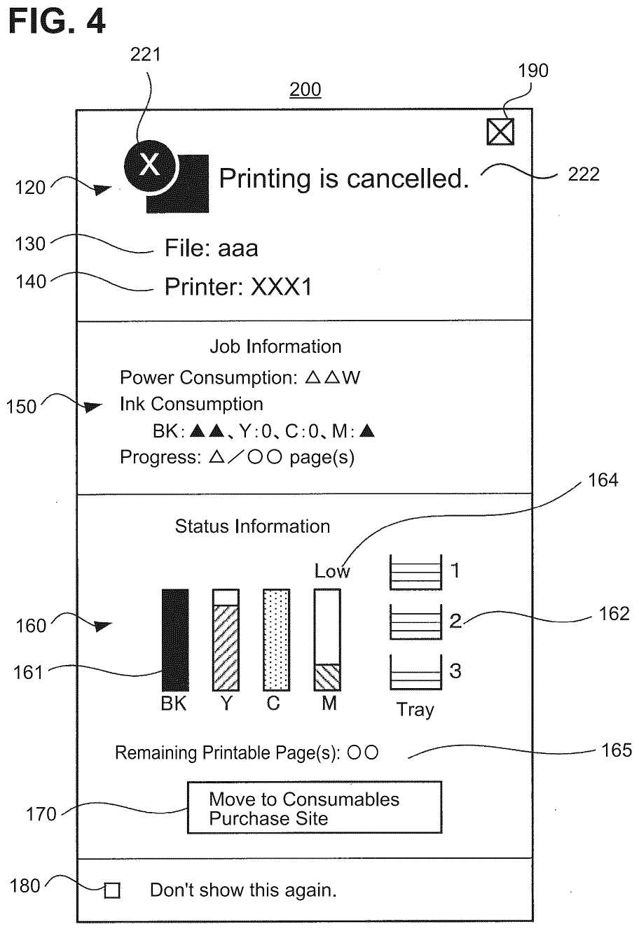

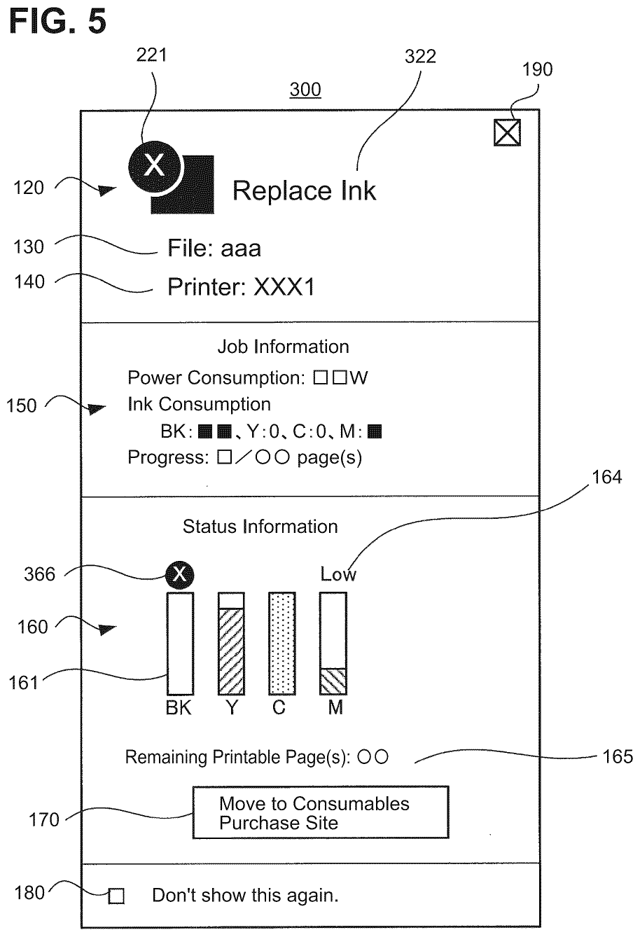

The display of the notification screen will be described in detail. For example, the supporting program 42 stores in advance a layout of the notification screen that notifies the end of the print job. The supporting program 42 obtains the information related to the print job end type obtained in step C35 (C36), and embeds the obtained information into the layout, thereby displaying, for example, the notification screen 100 in FIG. 3, the notification screen 200 in FIG. 4, or the notification screen 300 in FIG. 5, on the display 13a in the PC 1.

Each of the notification screens 100, 200, and 300 includes a print job result display area 120, a file name display area 130, a printer name display area 140, a job information display area 150, a status information display area 160, a consumables purchase site display button 170, a check box 180, and a close button 190.

For example, in a case where the supporting program 42 obtains the type information indicating “print completion” in step C35, the supporting program 42 obtains screen information including the information associated with “print completion” (C36) and displays the completion notification screen 100 of FIG. 3 on the display 13a (C37). The screen information including the information associated with “print completion” is an example of “first screen information”. The completion notification screen 100 is an example of a “notification screen” and a “first notification screen”.

More specifically, for example, the supporting program 42 obtains a print completion mark 121 and a message 122 as the information indicating the end of the print job, based on the type information indicating “print completion”. The message 122 may indicate the print job result, for example, “Printing is completed”. The supporting program 42 then embeds the print completion mark 121 and the message 122 in the print job result display area 120.

In addition, the supporting program 42 obtains and embeds the file name “aaa”, the printer name “XXX1”, the job information, and the status information into their corresponding areas, such as the file name display area 130, the printer name display area 140, the job information display area 150, and the status information display area 160. The job information includes the power consumption, the ink consumption, and the progress. The status information includes the ink levels, the sheet levels, and the remaining printable pages. The supporting program 42 displays the embedded information on the completion notification screen 100 together with the consumables purchase site display button 170, the check box 180, and the close button 190.

Displaying the completion notification screen 100 including such information may enable the user to confirm that the instructed print job has been completed, based on the print completion mark 121 and the message 122 displayed on the user IF 13 of the PC 1, even if the user is not physically near the printer 2. The user can also determine, based on the file name and the printer name displayed on the PC 1, which print job for a document or image file has been completed by which printer.

In addition, based on the job information, the user can confirm the power consumption and ink consumption for the specified print job, as well as whether all images contained in the print job have been printed. The user can also confirm the current consumable levels based on images 161 and 162 displayed in the status information display area 160. The image 161 may indicate ink levels. The image 162 may indicate sheet levels. The status information display area 160 may include a Low mark 164 that is added to a consumable running low. This may thus enable the user to recognize the consumable that will be soon need to be purchased.

For example, if the printer 2 manages the remaining printable pages for each user, the supporting program 42 may obtain remaining printable pages 165 for the user after the completion of the print job, as one of the data items of the status information from the printer 2 in step C36, and display the remaining printable pages 165 in the status information display area 160. This may thus enable the user to confirm the remaining printable pages 165 displayed on the completion notification screen 100, and if necessary, to perform a procedure to increase the remaining printable pages.

If the current print job is canceled by a user's operation on a main body of the printer 2, the supporting program 42 obtains type information indicating “print cancellation” in step C35. In this case, the supporting program 42 obtains screen information including the information associated with “print cancellation” (C36), and displays the cancellation notification screen 200 of FIG. 3 on the display 13a (C37). The screen information including the information associated with “print cancellation” is an example of “second screen information”. The cancellation notification screen 200 is another example of the “notification screen” and an example of a “second notification screen”.

More specifically, for example, the supporting program 42 obtains a print cancellation mark 221 and a message 222 as the information indicating the end of the print job, based on the type information indicating “print cancellation”. The message 122 may indicate the print job result, for example, “Printing is canceled”. The supporting program 42 then embeds the print cancellation mark 221 and the message 222 in the print job result display area 120. Further, the supporting program 42 embeds various information into the corresponding display areas such as the file name display area 130, the printer name display area 140, the job information display area 150, and the status information display area 160, as with the case of displaying the completion notification screen 100. The supporting program 42 displays the embedded information on the cancellation notification screen 200 together with the consumables purchase site display button 170, the check box 180, and the close button 190.

Displaying the cancellation notification screen 200 containing such information may enable the user to confirm that the instructed print job has been canceled, based on the print cancellation mark 221 and the message 222 displayed on the user IF 13 of the PC 1, even if the user is not physically near the printer 2. The user can also determine, based on the file name and the printer name displayed on the PC 1, which print job for a document or image file has been canceled by which printer.

The progress in the job information display area 150 indicates the number of pages printed before the current print job was canceled. Therefore, the user can determine how much of the print job instructed by the user has been completed. When the user instructs the printer to print the remaining pages of the same document file or image file next time, the user can specify only the pages that were not printed.

If the printer 2 ends the current print job due to termination caused by an error, such as insufficient black ink, the supporting program 42 obtains type information indicating “termination due to an error” in step C35. In this case, the supporting program 42 obtains screen information including the information associated with an insufficient ink error (C36), and displays the error notification screen 300 on the display 13a (C37). The error notification screen 300 is another example of the notification screen.

More specifically, for example, the supporting program 42 obtains the print cancellation mark 221 and a message 322 as the information indicating the end of the print job, based on the type information indicating “termination due to an error”. The message 322 may indicate the cause of the error, for example, “Replace Ink”. The supporting program 42 then embeds the print cancellation mark 221 and the message 322 in the print job result display area 120. Further, the supporting program 42 embeds various information into the corresponding display areas such as the file name display area 130, the printer name display area 140, the job information display area 150, and the status information display area 160, as with the case of displaying the completion notification screen 100. The supporting program 42 displays the embedded information on the error notification screen 300 together with the consumables purchase site display button 170, the check box 180, and the close button 190. The supporting program 42 adds an empty mark 366 indicating insufficient ink, to the color that is running out, in the status information display area 160.

Displaying the error notification screen 300 containing such information may enable the user to confirm that the instructed print job has been ended due to termination caused by an insufficient ink error, based on the print cancellation mark 221 and the message 322 displayed on the user IF 13 of the PC 1, even if the user is not physically near the printer 2. The user can also determine, based on the file name and the printer name, which print job for a document or image file has been ended by which printer due to termination caused by an insufficient ink error.

In addition, the user can determine which color of ink cartridge need to be replaced based on the location of the empty mark 366. When purchasing a replacement for the ink cartridge with insufficient ink, the user operates the consumables purchase site display button 170 via the user IF 13. In response to the user's operation, the supporting program 42 passes the URL associated with the consumables purchase site display button 170 to another program such as a browser incorporated in the PC 1, for example. For example, the browser is provided with a purchase screen specified by the URL from the server and displays the purchase screen on the display 13a of the PC 1. This may thus enable the user to proceed with an ink cartridge purchasing procedure.

In response to an operation on the close button 190 of any notification screen via the user IF 13, the supporting program 42 ends the display of the notification screen. In the illustrative embodiment, the supporting program 42 controls the display of the notification screens. Nevertheless, in other embodiments, for example, the OS 21 may control the display of the notification screens in response to a request from the supporting program 42.

After ending the display of the notification screen, the supporting program 42 executes a restriction setting process to update the restriction setting information 48 (C62). The restriction setting information 48 is stored in a nonvolatile area of the memory 12, and includes a flag indicating whether to display a notification screen. For example, in the restriction setting information 48, the flag is turned ON when the supporting program 42 receives a specification to enable the restriction setting, and the flag is turned OFF when the supporting program 42 receives a specification to disable the restriction setting. In the illustrative embodiment, the notification screen displayed by the supporting program 42 includes the check box 180 that allows the user to enable or disable the restriction setting on the display of the notification screen. The supporting program 42 can update the restriction setting information 48 in accordance with whether the check box 180 is checked or unchecked.

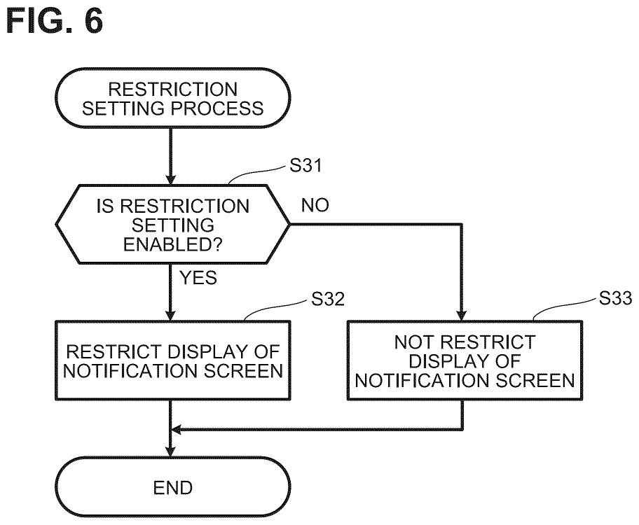

More specifically, for example, as illustrated in the flowchart of FIG. 6, the CPU 11 determines whether the restriction setting is enabled (S31). If the display of the completion notification screen 100 is ended in a state where the check box 180 on the completion notification screen 100 is unchecked, the CPU 11 determines that the restriction setting is not enabled (S31: NO). In this case, the CPU 11 sets the flag in the restriction setting information 48 to OFF, thereby not restricting the display of the notification screen (S33), and then ends the restriction setting process. Thus, the supporting program 42 executes the screen display process of step C37 to display the notification screen in the same manner as described above when the next print job is processed.

If the display of the notification screen 100 is ended in a state where the check box 180 on the notification screen 100 is checked, the CPU 11 determines that the restriction setting is enabled (S31: YES). In this case, the CPU 11 sets the flag in the restriction setting information 48 to ON, thereby restricting the display of the notification screen (S32), and then ends the restriction setting process. Thus, the supporting program 42 does not execute the screen display process in step S37 when the next print job is processed, and thus does not display the notification screen on the user IF 13. The processing in which the CPU 11 receives specification of the restriction setting via the check box 180 is an example of “restriction setting processing”.

In other embodiments, for example, an item related to the setting of the restriction setting information 48 may be provided on an option setting screen of the supporting program 42, allowing the user to change the restriction setting information 48. For example, if the user docs not need to be notified of the print job result each time a print job is processed, the user can close the notification screen with the check box 180 being checked. This restriction setting remains enabled unless the user disables the restriction setting on the option setting screen. This may avoid the inconvenience of the notification screen being displayed for each print job.

As described above in detail, in the first illustrative embodiment, when an end event is output from the universal printing program 41 in response to a print instruction, the supporting program 42 displays the notification screen 100, 200, or 300 that includes the information associated with the end of the print job in the printer 2. Such a configuration may thus enable the user to obtain the necessary information when the print job ends in the printer 2. The supporting program 42 thus might not need to monitor the printer 2 after transmission of print data. Thus, a communication load on the supporting program 42 may be lightened when the end of the print job in the printer 2 is notified.

### Second Illustrative Embodiment

Next, a second illustrative embodiment will be described. In the second illustrative embodiment, the supporting program 42 has a function of notifying the end of the print job in the printer 2 when an error event is output from the universal printing program 41. This point differs from the first illustrative embodiment, in which the supporting program 42 notifies the end of the print job in response to an end event output from the universal printing program 41, while other aspects are common to the first illustrative embodiment. Hereinafter, the description will focus on the differences from the first illustrative embodiment, and the configurations and processes common to the first illustrative embodiment will be denoted by the same reference numerals and omitted from description as appropriate.

Some universal printing program 41 might not have a function of issuing an end event based on an end notification, but may have a function of issuing an error event based on an error notification. This embodiment may be designed for such a case. For example, the end of the print job in the printer 2 may be notified from the printer 2 to the supporting program 42 by disguising the end of the print job as one of the error types that can be reported, thereby using an error event, based on an error notification from the universal printing program 41, as an end event.

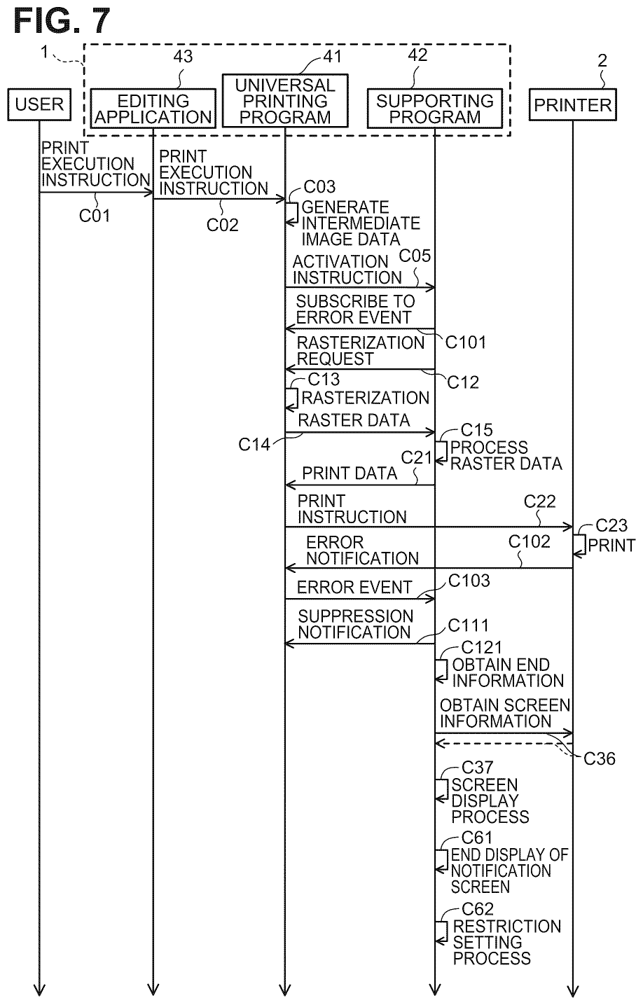

As illustrated in FIG. 7, the supporting program 42 subscribes to an error event from the universal printing program 41 (C101). An error event can be output from the universal printing program 41 when the universal printing program 41 receives an error notification from the printer 2 used for printing. Subscribing to an error event from the universal printing program 41 enables the supporting program 42 to receive an error event from the universal printing program 41.

As with the timing for subscribing an end event according to the first illustrative embodiment, the timing for subscribing to an error event (refer to step C11) can be at any time after the supporting program 42 is activated in response to a print instruction (i.e., after the supporting program 42 receives an activation instruction in step C05) and before the supporting program 42 executes a printing process (i.e., before the supporting program 42 outputs print data in step C21). In this illustrative embodiment, the supporting program 42 subscribes to an error event from the universal printing program 41 every time a print instruction is provided. Nevertheless, if the universal printing program 41 can maintain the error event subscription, the supporting program 42 may omit step C101.

When the printer 2 ends the processing of the print job based on the print data, the printer 2 transmits an error notification to the universal printing program 41 that has output the print instruction (C102). The error notification includes end information indicating the end of the print job in the printer. Examples of the end information include “print completion”, “print cancellation”, and “termination due to an error”. The end information might not necessarily be interpreted by the universal printing program 41, and may be interpreted as a type of actual error by the universal printing program 41.

In response to receiving, from the printer 2, the error notification including the end information (C102), the universal printing program 41 outputs an error event based on the established error event subscription (C103). For example, the universal printing program 41 outputs an error event including the end information included in the error notification.

In response to receiving the error event from the universal printing program 41 in step C103, the supporting program 42 passes a suppression notification to the universal printing program 41 to enable an error notification suppression setting in the universal printing program 41 (C111). The suppression notification may specify that error notifications are unnecessary. Step C111 is an example of “setting processing”.

The universal printing program 41 has a function of automatically displaying an error notification screen on the user IF 13 to notify the occurrence of an error in response to receiving an error notification from the printer 2, in a normal operation. In the present embodiment, as described above, even when a print job is completed successfully, an error notification is output from the printer 2. That is, the error is disguised. The universal printing program 41 always notifies an error in response to an error notification. Therefore, an error may be notified based on the interpretation of the universal printing program 41 even though the print job has actually completed successfully. Thus, in response to receiving, from the universal printing program 41, an error event, the supporting program 42 outputs a suppression notification to the universal printing program 41 to avoid such a problem. The suppression notification may specify that error notifications are unnecessary.

The supporting program 42 obtains the end information included in the error event received from the universal printing program 41 (C121). Step C121 is an example of “end information obtaining processing”. The supporting program 42 can obtain the end information without communicating with the printer 2.

In one example, the error notification may include an error code. Each error code uniquely identifies a print job end type. In this case, the universal printing program 41 may output an error event corresponding to the error code. In this case, the supporting program 42 may obtain the end information by analyzing the type of the error event.

The supporting program 42 obtains screen information based on the end information obtained in step C121 (C36), and displays a notification screen based on the obtained screen information on the display 13a of the PC 1 (C37).

As described above, in the second illustrative embodiment, the universal printing program 41 may be unable to output an end event corresponding to an end notification, but may output an error event corresponding to an error notification. Even in such a case, since the error notification transmitted from the printer 2 includes end information, the supporting program 42 can obtain the end information from the error notification, thereby determining that the print job has been completed. Therefore, the supporting program 42 may obtain screen information in accordance with the determination result, and display a notification screen on the display 13a of the PC 1. That is, the supporting program 42 may enable the user to recognize the end of the print job in the printer 2 by displaying a notification screen according to the print job end type on the display 13a of the PC 1 while reducing the communication load with an external device such as the printer 2.

While the disclosure has been described in detail with reference to the specific embodiment thereof, this is merely an example, and various changes, arrangements and modifications may be applied therein without departing from the spirit and scope of the disclosure. Any apparatuses or devices having a printing function may be connected to the PC 1. Examples of such apparatuses or devices include multifunction peripherals, copying machines, and facsimile machines. A plurality of printers, for example, two or more printers may be connected to the PC 1.

If it is normal for the universal printing program 41 to notify the end of the print job, the supporting program 42 enables the notification suppression setting in the universal printing program 41. This may thus avoid notifications of the end of the print job from the universal printing program 41. Such a configuration may thus avoid duplicate notifications notifying of the end of the print job from both the universal printing program 41 and the supporting program 42.

In the illustrative embodiment, the notification screen for an insufficient consumable is displayed, taking insufficient ink as an example of the “termination due to an error”. Nevertheless, in other embodiments, a notification screen may be displayed when a consumable other than ink, such as sheets, becomes insufficient or when an error other than the insufficient consumable, such as “Cover Open”.

The screens to be displayed on the user IF 13 illustrated in the illustrative embodiment are all examples. In one example, the job information display area 150 of each of the notification screens 100, 200, and 300 might not necessarily include power consumption, ink consumption, or both. In another example, each of the notification screens 100, 200, and 300 might not necessarily include the consumables purchase site display button 170. In another example, the completion notification screen 100, the cancellation notification screen 200, and the error notification screen 300 may have different layouts. In another example, the cancellation notification screen 200 might not include the status information display area 160, the consumables purchase site display button 170, or both. In another example, instead of the consumables purchase site display button 170, the notification screen may include the link to the consumables purchase site URL, or may simply include the consumables purchase site URL as text.

In another example, the supporting program 42 may display the completion notification screen when the print job is completed, but might not display the cancellation notification screen or the error notification screen when the print job is canceled or when an error occurs. In another example, the supporting program 42 may subscribe a completion event from the universal printing program 41 in step C11 of FIG. 2. In response to receiving, from the printer 2, a completion notification indicating that the print job is completed, the universal printing program 41 may output a completion event. In response to receiving a completion event from the universal printing program 41, the supporting program 42 may obtain screen information including the information associated with “print completion” or the information indicating “print completion”, and display the completion notification screen 100 based on the obtained information. The end of a print job in the printer may include “print completion” or “print cancellation”. Thus, depending on the case, a different notification screen, such as the completion notification screen 100 or the cancellation notification screen 200, is displayed on the display 13a of the PC 1. This may enable the user to clearly recognize whether the displayed information relates to a completed print job or a canceled print job in the printer 2. Further, when a print job is completed, information appropriate to the completion of the print job is notified. When a print job is canceled, information appropriate to the cancellation of the print job is notified. Thus, the user may readily obtain necessary information.

In another example, a printer name may be omitted from the screen information obtained in step C36, so that a notification screen does not include the printer name. Nevertheless, it may be preferable for the notification screen to include the printer name. Including the printer name may enable the user to identify which printer has ended the processing of the print job.

In another example, a file name of a file that including an image to be printed may be omitted from the screen information obtained in step C36, so that a notification screen does not include the file name. Nevertheless, it may be preferable for the notification screen to include the file name. Including the file name may enable the user to identify which file has been processed.

In another example, job information corresponding to a print instruction may be omitted from the screen information obtained in step C36, so that a notification screen does not include the job information. Nevertheless, it may be preferable for the notification screen to include the job information. Including the job information may enable the user to obtain the job information related to the current print job.

In another example, status information indicating the printer state may be omitted from the screen information obtained in step C36, so that a notification screen does not include the status information. Nevertheless, it may be preferable for the notification screen to include the status information. Including the status information may enable the user to obtain the status information related to the printer status.

In another example, the check box 180 that allows the user to enable or disable the restriction setting on the display of the notification screen may not be omitted from the notification screens 100, 200, and 300, so that step C62 in FIGS. 2 and 7 is omitted. That is, the supporting program 42 may be configured such that the error notification suppression setting in the universal printing program 41 cannot be enabled. Nevertheless, displaying the notification screen every time a print job is processed may cause inconvenience to the user. Thus, it may be preferable to restrict the display of the notification screen by allowing the user to enable the restriction setting on the display of the notification screen, thereby reducing user inconvenience.

The restriction setting may be enabled or disabled on a screen different from the notification screen. That is, the restriction setting may be enabled or disabled at a timing different from the timing of displaying the notification screen. Nevertheless, it may be preferable to allow the user to enable or disable the restriction setting on the notification screen, thereby eliminating the need to open another screen for the restriction setting and thus reducing user inconvenience.

Step C111 in FIG. 7 may be omitted. In other words, both the supporting program 42 and the universal printing program 41 may notify the user of the end of a print job. However, it is preferable that if it is normal for the universal printing program 41 to notify errors, the supporting program 42 passes a suppression notification to the universal printing program 41 and enables the error notification suppression setting in the universal printing program 41. This may thus avoid duplicate error notifications from both the universal printing program 41 and the supporting program 42.

In the illustrative embodiment, the description has been provided on only the printing operation in which the supporting program 42 is involved. However, the supporting program 42 may be involved in another operation in addition to the printing operation. Any program may be applicable instead of the supporting program 42, as long as the program receives an instruction from the OS 21 or the universal printing program 41 when a print job is performed using the universal printing program 41. For example, the alternative program may be a print workflow application (PrintWorkflow) whose specification has been disclosed by Microsoft Corporation.

In any flowchart disclosed in the illustrative embodiment, steps may be executed in a different order or in parallel, as long as no contradiction occurs in the contents of the procedures.

The processing in all steps disclosed in the illustrative embodiment may be executed by hardware, such as a single CPU, multiple CPUs, an ASIC, or a combination thereof. The processing in all steps disclosed in the embodiment may be implemented in various aspects such as a recording medium storing a computer-readable program for executing the processing, or a method.

What is claimed is:

1. A non-transitory computer-readable storage medium for an information processing device, the information processing device including a controller, the non-transitory computer-readable storage medium storing computer-executable instructions for implementing a supporting program for a printer connectable to the information processing device, wherein the information processing device has an operating system including a universal printing program, the information processing device is incorporated with an application program, the supporting program that, when executed by the controller, causes the information processing device to perform:
in response to the universal printing program receiving, from the application program, a print instruction for a print job that causes the printer to print an image to be printed,
printing processing of causing the printer to process the print job to print the image to be printed;
receiving processing of receiving an end event from the universal printing program, the end event being output by the universal printing program in response to the universal printing program receiving an end notification from the printer as a result of processing the print job;
in response to receiving the end event from the universal printing program, screen information obtaining processing of obtaining screen information including information associated with an end of the print job in the printer; and
notification processing of displaying a notification screen based on the screen information on a user interface of the information processing device.

2. The non-transitory computer readable storage medium according to claim 1,
wherein the end notification includes a completion notification indicating that the print job based on the print instruction has been completed in the printer,
wherein the supporting program, when executed by the controller, causes the information processing device to perform:
receiving processing of receiving a completion event from the universal printing program as the end event, the completion event being output by the universal printing program in response to the universal printing program receiving the completion notification from the printer, and
wherein the screen information obtaining processing includes obtaining the screen information including information associated with the completion of the print job in the printer in response to receiving the completion event from the universal printing program.

3. The non-transitory computer readable storage medium according to claim 2,
wherein the screen information obtaining processing includes obtaining the screen information including information indicating the completion of the print job in the printer in response to receiving the completion event from the universal printing program.

4. The non-transitory computer readable storage medium according to claim 1,
wherein the supporting program, when executed by the controller, causes the information processing device to perform:
in response to receiving the end event from the universal printing, end type obtaining processing of obtaining type information indicating an end type of the print job, and
wherein the screen information obtaining processing includes obtaining the screen information based on the type information.

5. The non-transitory computer readable storage medium according to claim 4,
wherein the end type indicated by the type information is one of a plurality of end types,
wherein the plurality of end types includes a print completion and a print cancellation,
wherein the screen information obtaining processing includes:
in a case where the end type indicated by the type information indicates the print completion, obtaining first screen information associated with the print completion; and
in a case where the end type indicated by the type information indicates the print cancellation, obtaining second screen information associated with the print cancellation, and
wherein the notification processing includes:
in a case where the first screen information is obtained, displaying a first notification screen based on the first screen information on the user interface as the notification screen; and
in a case where the second screen information is obtained, displaying a second notification screen based on the second screen information on the user interface as the notification screen.

6. The non-transitory computer readable storage medium according to claim 1,
wherein the screen information further includes a printer name identifying the printer, and
wherein the notification screen includes the printer name.

7. The non-transitory computer readable storage medium according to claim 1,
wherein the screen information further includes a file name identifying a file to be printed based on the print instruction, and
wherein the notification screen includes the file name.

8. The non-transitory computer readable storage medium according to claim 7,
wherein the screen information obtaining processing includes obtaining the file name from the universal printing program, the file name identifying the file to be printed based on the print instruction, the file corresponding to the end notification received by the universal printing program from the printer.

9. The non-transitory computer readable storage medium according to claim 1,
wherein the screen information further includes job information related to the print job based on the print instruction, and
wherein the notification screen includes the job information.

10. The non-transitory computer readable storage medium according to claim 1,
wherein the screen information further includes status information based on a status of the printer, and
wherein the notification screen includes the status information.

11. The non-transitory computer readable storage medium according to claim 1,
wherein the supporting program, when executed by the controller, causes the information processing device to perform:
restriction setting processing of enabling a setting to restrict the display of the notification screen; and
in response to the setting being enabled, omitting the screen information obtaining processing and the notification processing even when receiving the end event from the universal printing program.

12. The non-transitory computer readable storage medium according to claim 1,
wherein the supporting program, when executed by the controller, causes the information processing device to perform:
receiving processing of receiving an error event from the universal printing program, the error event being output by the universal printing program in response to the universal printing program receiving an error notification, as the end notification, from the printer as the result of processing the print job, the error notification including end information indicating the end of the print job in the printer, and
wherein the screen information obtaining processing includes obtaining the screen information based on the end information.

13. The non-transitory computer readable storage medium according to claim 12,
wherein the supporting program, when executed by the controller, causes the information processing device to perform:
in response to receiving the error event from the universal printing program, setting processing of enabling an error notification suppression setting in the universal printing program, wherein:
when the error notification suppression setting is disabled, the universal printing program notifies an error in response to receiving the error notification from the printer; and
when the error notification suppression setting is enabled, the universal printing program does not notify an error in response to receiving the error notification from the printer.

14. A non-transitory computer-readable storage medium for an information processing device, the information processing device including a controller, the non-transitory computer-readable storage medium storing computer-executable instructions for implementing a supporting program, wherein the information processing device has an operating system including a universal printing program, the supporting program that, when executed by the controller, causes the information processing device to perform:
in response to receiving a print job from the universal printing program, causing a printer to process the print job;
receiving an end event from the universal printing program, the end event being output by the universal printing program in response to the universal printing program receiving an end notification from the printer as a result of processing the print job;
in response to receiving the end event from the universal printing program, obtaining screen information including information associated with an end of the print job in the printer; and
displaying a notification screen based on the screen information on a user interface of the information processing device.

15. The non-transitory computer readable storage medium according to claim 14,
wherein the supporting program, when executed by the controller, causes the information processing device to perform:
receiving a completion event from the universal printing program as the end event, the completion event being output by the universal printing program in response to the universal printing program receiving a completion notification from the printer as the end notification, the completion notification indicating that the print job based on the print instruction has been completed in the printer, and
wherein the obtaining the screen information includes obtaining the screen information including information associated with the completion of the print job in the printer in response to receiving the completion event from the universal printing program.

16. The non-transitory computer readable storage medium according to claim 15,
wherein the obtaining the screen information includes obtaining the screen information including information indicating the completion of the print job in the printer in response to receiving the completion event from the universal printing program.

17. The non-transitory computer readable storage medium according to claim 14,
wherein the supporting program, when executed by the controller, causes the information processing device to perform:
in response to receiving the end event from the universal printing, obtaining type information indicating an end type of the print job, and
wherein the obtaining the screen information includes obtaining the screen information based on the type information.

18. The non-transitory computer readable storage medium according to claim 17,
wherein the end type indicated by the type information is one of a plurality of end types,
wherein the plurality of end types includes a print completion and a print cancellation,
wherein the obtaining the screen information includes:
in a case where the end type indicated by the type information indicates the print completion, obtaining first screen information associated with the print completion; and
in a case where the end type indicated by the type information indicates the print cancellation, obtaining second screen information associated with the print cancellation, and
wherein the displaying the notification screen includes:
in a case where the first screen information is obtained, displaying a first notification screen based on the first screen information on the user interface as the notification screen; and
in a case where the second screen information is obtained, displaying a second notification screen based on the second screen information on the user interface as the notification screen.

19. The non-transitory computer readable storage medium according to claim 14,
wherein the supporting program, when executed by the controller, causes the information processing device to perform:
enabling a setting to restrict the display of the notification screen; and
in response to the setting being enabled, omitting the obtaining the screen information and the displaying the notification screen even when receiving the end event from the universal printing program.

20. The non-transitory computer readable storage medium according to claim 14,
wherein the supporting program, when executed by the controller, causes the information processing device to perform:
receiving an error event from the universal printing program, the error event being output by the universal printing program in response to the universal printing program receiving an error notification, as the end notification, from the printer as the result of processing the print job, the error notification including end information indicating the end of the print job in the printer, and
wherein the obtaining the screen information includes obtaining the screen information based on the end information.
